(19) United States
(12) Patent Application Publication
(10) Pub. No.: US 2025/0114899 A1
(43) Pub. Date: Apr. 10, 2025

(54) CMP WITH INDIVIDUALLY ROTATABLE PLATENS

(71) Applicant: Applied Materials, Inc., Santa Clara, CA (US)

(72) Inventors: Eric Lau, Santa Clara, CA (US); Jeonghoon Oh, Saratoga, CA (US); Ekaterina A. Mikhaylichenko, San Jose, CA (US); Andrew J. Nagengast, Sunnyvale, CA (US); Takashi Fujikawa, San Jose, CA (US); Kuen-Hsiang Chen, Sunnyvale, CA (US); Jay Gurusamy, Santa Clara, CA (US); Steven M. Zuniga, Soquel, CA (US); Huanbo Zhang, San Jose, CA (US)

(21) Appl. No.: 18/481,576

(22) Filed: Oct. 5, 2023

(51) Int. Cl. B24B 37/10; B24B 37/34

(52) U.S. Cl. CPC B24B 37/105; B24B 37/34

(57) ABSTRACT

A chemical mechanical polishing apparatus includes an inner platen to support an inner polishing pad, aan annular outer platen to support an outer polishing pad, a carrier head to hold a substrate, a first motor to rotate the inner platen about a vertical axis at a first rotation rate, and a second motor to rotate the outer platen about the vertical axis at a second rotation rate. The outer polishing pad coaxially surrounds the inner platen, and an outer edge of the inner platen and an inner edge of the outer platen are separated by a gap.

### TECHNICAL FIELD

The disclosure relates to chemical mechanical polishing, and more specifically to a polishing station with multiple concentric platens.

### BACKGROUND

An integrated circuit is typically formed on a substrate by the sequential deposition of conductive, semiconductive, or insulative layers on a silicon wafer. One fabrication step involves depositing a filler layer over a non-planar surface and planarizing the filler layer. For certain applications, the filler layer is planarized until the top surface of a patterned layer is exposed. A conductive filler layer, for example, can be deposited on a patterned insulative layer to fill the trenches or holes in the insulative layer. After planarization, the portions of the metallic layer remaining between the raised pattern of the insulative layer form vias, plugs, and lines that provide conductive paths between thin film circuits on the substrate. For other applications, such as oxide polishing, the filler layer is planarized, e.g., by polishing for a predetermined time period, to leave a portion of the filler layer over the nonplanar surface. In addition, planarization of the substrate surface is usually required for photolithography.

One problem in CMP is variations in the material removal rate, and subsequent thickness profile, of the substrate. Variations in the slurry distribution, polishing pad condition, the relative speed between the polishing pad and the substrate, and the inconsistent load on the substrate from the pressurized chambers of the carrier head can cause variations in the material removal rate. These variations, as well as variations in the initial thickness of the substrate layer, cause variations final substrate layer thickness, particularly near the edge of the substrate.

### SUMMARY

In one aspect, a chemical mechanical polishing apparatus includes: an inner platen to support an inner polishing pad; an annular outer platen to support an outer polishing pad; a carrier head to hold a substrate; one or more motors to rotate the inner platen about a vertical axis at a first rotation rate and to rotate the outer platen about the vertical axis at a second rotation rate; and a controller configured to select values for multiple control parameters to minimize a difference between a target removal profile and an expected removal profile, the multiple control parameters including a first parameter representing a difference in rotational speeds between the inner and outer platens. The outer polishing pad can coaxially surround the inner platen, and an outer edge of the inner platen and an inner edge of the outer platen can be separated by a gap. A relationship between the multiple control parameters and a removal rate can be stored in a data structure representing a first matrix which includes multiple columns including a column for the difference in rotational speeds and a row for each position on the substrate represented in the expected removal profile. The controller can be configured to, as part of selection of the values, calculate the expected removal profile by multiplying the first matrix by a second matrix representing control parameter values.

In another aspect, a chemical mechanical polishing apparatus includes: an inner platen to support an inner polishing pad; an annular outer platen to support an outer polishing pad; a carrier head to hold substrate; a motor to rotate the inner platen about a first vertical axis; an actuator to move the carrier head to laterally; and a controller configured to cause the actuator to sweep the carrier head laterally in accord with a sweep profile. The outer platen can coaxially surround the inner platen, and an outer edge of the inner platen and an inner edge of the outer platen can be separated by a gap. The controller can be configured to select values for multiple control parameters to minimize a difference between a target removal profile and an expected removal profile, the multiple control parameters including multiple dwell time parameters with each respective dwell time parameter of the multiple dwell time parameters representing an amount of time for the carrier head to spend over multiple positions with at least one of the multiple positions corresponding to substrate being positioned over just one of the inner and outer polishing pads and at least another of the multiple positions corresponding to substrate being positioned over both the inner and outer polishing pads. A relationship between the multiple control parameters and a removal rate can be stored in a data structure representing a first matrix which includes multiple columns including a column for each dwell time parameter and a row for each position on the substrate represented in the expected removal profile. The controller can be configured to, as part of selection of the values, calculate the expected removal profile by multiplying the first matrix by a second matrix representing control parameter values.

In another aspect, a method for chemical mechanical polishing includes: rotating an inner platen including a first polishing pad at a first rotational speed; rotating an outer platen including a second polishing pad at a second rotational speed different from the first rotational speed; and selecting values for multiple control parameters to minimize a difference between a target removal profile and an expected removal profile, the multiple control parameters including a first parameter representing a relative rotational speed between the first and second rotational speeds. An outer edge of the inner platen and an inner edge of the outer platen can be separated by a gap. A relationship between the multiple control parameters and a removal rate can be stored in a data structure representing a first matrix which includes multiple columns including a column for the relative rotational speed and a row for each position on a substrate represented in the expected removal profile. Selecting the values for the multiple control parameters can include calculating the expected removal profile by multiplying the first matrix by a second matrix representing control parameter values.

In another aspect, a chemical mechanical polishing apparatus includes: an inner platen to support an inner polishing pad; an annular outer platen to support an outer polishing pad; a carrier head to hold a substrate; a first motor to rotate the inner platen about a vertical axis at a first rotation rate; and a second motor to rotate the outer platen about the vertical axis at a second rotation rate. The outer polishing pad coaxially can surround the inner platen, and an outer edge of the inner platen and an inner edge of the outer platen can be separated by a gap.

In another aspect, a chemical mechanical polishing apparatus includes: an inner platen to support an inner polishing pad; an annular outer platen to support an outer polishing pad; a carrier head to hold a substrate; one or more motors to rotate the inner platen about a vertical axis at a first rotation rate and rotate the outer platen about the vertical axis at a second rotation rate; and one or more nozzles positioned to spray a cleaning liquid into the gap. The outer polishing pad can coaxially surround the inner platen, and an outer edge of the inner platen and an inner edge of the outer platen can be separated by a gap.

In another aspect, a chemical mechanical polishing apparatus includes: an inner platen to support an inner polishing pad; an annular outer platen to support an outer polishing pad; a carrier head to hold a substrate; one or more motors to rotate the inner platen about a vertical axis at a first rotation rate and rotate the outer platen about the vertical axis at a second rotation rate; a passage through the inner platen or outer platen with one or more openings in a sidewall of the inner platen or outer platen into the gap; and a cleaning liquid source coupled to the passage to direct cleaning liquid through the one or more openings into the gap. The outer polishing pad can coaxially surround the inner platen, and an outer edge of the inner platen and an inner edge of the outer platen can be separated by a gap.

Implementations may include one or more of the following features.

The controller can be configured to receive a first rotational speed for the inner platen from a recipe that is stored prior to polishing and to calculate a second rotational speed for the outer platen from the first rotational speed and the difference in rotational speeds.

The controller can be configured to receive a first rotational speed for the outer platen from a recipe that is stored prior to polishing and to calculate a second rotational speed for the inner platen from the first rotational speed and the difference in rotational speeds.

The controller can be configured to apply a minimizing algorithm to reduce a difference between an expected thickness profile and a target thickness profile. Applying the minimizing algorithm can include iteratively calculating the expected removal profile using different values for the difference in rotational speeds.

The chemical mechanical polishing apparatus can include an actuator. The carrier head can be laterally movable by the actuator.

The controller can be configured to cause the actuator to oscillate the carrier head between a first position where the substrate is entirely over the outer polishing pad and a second position where the substrate is partially over the outer polishing pad and partially over the inner polishing pad.

The controller can be configured to cause the actuator to oscillate the carrier head between a first position where the substrate is entirely over the inner polishing pad and a second position where the substrate is partially over the inner polishing pad and partially over the outer polishing pad.

The controller can be configured to calculate a sweep profile from values for the multiple dwell time parameters.

The controller can be configured to set the sweep profile with a respective speed for each respective annular zone of multiple annular zones on each of the inner and outer platens.

The controller can be configured to set the respective speed for each respective annular zone of the multiple annular zones as a constant value within the respective annular zone.

Values for the multiple dwell time parameters can be in units of a fraction of total time.

The controller can be configured to calculate a sweep speed for each respective annular zone of the multiple annular zones as inversely proportional to the values for the multiple the dwell time parameters for each respective annular zone.

A fractional dwell time value for the multiple annular zones can be proportional to an oscillation period of the sweep profile.

The method can include receiving the first rotational speed for the inner platen from a recipe that is stored prior to polishing; and calculating the second rotational speed for the outer platen from the first rotational speed and the relative rotational speed.

The method can include receiving the second rotational speed for the outer platen from a recipe that is stored prior to polishing; and calculating the first rotational speed for the inner platen from the second rotational speed and the relative rotational speed.

The method can include applying a minimizing algorithm to reduce a difference between an expected thickness profile and a target thickness profile. Applying the minimizing algorithm can include iteratively calculating the expected removal profile using different values for the relative rotational speed.

The method can include oscillating a carrier head between a first position where the substrate is entirely over the inner polishing pad and a second position where the substrate is partially over the inner polishing pad and partially over the outer polishing pad.

The multiple control parameters can include multiple dwell time parameters representing an amount of time for the carrier head to spend over multiple positions with at least one of the multiple positions corresponding to substrate being positioned over just one of the inner and outer polishing pad and at least another of the multiple positions corresponding to substrate being positioned over both the inner and outer polishing pad.

The method can include calculating a sweep profile from values for the multiple dwell time parameters.

The method can include setting the sweep profile with a respective speed for each respective annular zone of multiple annular zones on each of the inner and outer platens.

The method can include setting the respective speed for each respective annular zone of the multiple annular zones as a constant value within the respective annular zone.

The chemical mechanical polishing apparatus can include a drive shaft colinear with the vertical axis coupling the first motor to the inner platen.

The chemical mechanical polishing apparatus can include a first gear attached to one of the inner platen or outer platen and positioned to engage a toothed surface of the other of the inner platen or outer platen. The first gear can be driven by the second motor and rotates about a second vertical axis.

The first gear can be attached to the inner platen and positioned to engage a toothed surface of the outer platen, and the second vertical axis can move with the inner platen.

The second motor can be supported in a recess in the inner platen.

The first gear can be attached to the outer platen and is positioned to engage a toothed surface of the inner platen, and the second vertical axis can move with the outer platen.

The chemical mechanical polishing apparatus can include at least one geared flange engaged with a geared surface of the outer platen. The second motor can drive rotation of the geared flange to causes rotation of the outer platen.

The geared flange can rotate about a horizontal axis and engage a lower surface of the outer platen.

The geared flange can rotate about a vertical axis and engage a cylindrical outer surface of the outer platen.

The chemical mechanical polishing apparatus can include a belt that engages an outer surface of the outer platen. The belt can be driven by the second motor.

The chemical mechanical polishing apparatus can include one or more nozzles for spraying a cleaning liquid into the gap.

The chemical mechanical polishing apparatus can include a passage through the inner platen with one or more openings into the gap and out of the inner platen.

The chemical mechanical polishing apparatus can include a cleaning liquid source coupled to the passage to direct cleaning liquid through the one or more openings into the gap.

The chemical mechanical polishing apparatus can include a conduit through the inner platen or the outer platen with one or more openings in a sidewall of the inner platen or the outer platen into the gap.

The nozzles can be horizontally fixed.

The chemical mechanical polishing apparatus can include a deionized water source to provide cleaning fluid to the one or more nozzles.

The passage can be through the inner platen and have one or more openings in the sidewall of the inner platen.

The passage can be through the outer platen and have one or more openings in the sidewall of the outer platen.

The chemical mechanical polishing apparatus can include a cleaning liquid source coupled to the passage to direct the cleaning liquid through the one or more openings into the gap.

The cleaning liquid can be deionized water.

The subject matter described in this specification can be implemented so as to realize one or more of the following advantages.

Polishing a substrate with two polishing pads rotating at different rotational speeds can allow for more fine-tuned control of a polishing profile as compared to using just one polishing pad. For example, by holding substrate in a position overlying both the inner and outer platens, over-polishing the edge of the substrate can be avoided, because the outer platen can be slowed down relative to the inner platen to reduce the polishing rate at the edge of the substrate. Conversely, under-polishing the edge of the substrate can be avoided, since the outer platen can be sped up relative to the inner platen to increase the polishing rate at the edge of the substrate. As another example, the disclosed polishing system and methods can allow the correction of asymmetry by synchronizing a sweep position with rotation of the inner and outer platens so that only desired angular positions of a substrate are exposed to the outer platen. In general, different annular zones of the substrate can experience different polishing rates as a result of using multiple platens rotating at different speeds. Uniformity and yield can be improved.

The details of one or more embodiments are set forth in the accompanying drawings and the description below. Other aspects, features and advantages will be apparent from the description and drawings, and from the claims.

### DESCRIPTION OF DRAWINGS

FIG. 1 illustrates a schematic cross-sectional view of an example of a polishing apparatus having an optical monitoring system and two concentric platens.

FIGS. 2A and 2B illustrate a schematic top-down view of motion of a substrate across polishing pads operable to rotate at different speeds.

FIGS. 3A and 3B illustrate a schematic top-down view of another implementation of motion of a substrate across polishing pads operable to rotate at different speeds.

FIGS. 4A and 4B illustrate schematic cross-sectional and top-down views, respectively, of a mechanism used to drive the inner and outer platens at different rotational speeds.

FIG. 4C illustrates a schematic cross-sectional view of another example of a mechanism used to drive the inner and outer platens at different rotational speeds.

FIG. 5 depicts a polishing apparatus with an example of a rinse system.

FIG. 6 illustrates schematic diagrams of example computing devices.

In the figures, like references indicate like elements.

### DETAILED DESCRIPTION

In some chemical mechanical polishing operations, a portion of a substrate can be under-polished or over-polished. In particular, the substrate tends to be over-polished or under-polished at or near the substrate edge. One technique to address such polishing non-uniformity is to have multiple controllable pressurizable chambers in the carrier head. However, pressure applied from the backside of the substrate tends to “spread,” such that compensation for radially localized polishing non-uniformity can be difficult. Another technique is to transfer the substrate to a separate “touch up” tool, e.g., to perform edge-correction. However, the additional tool consumes valuable footprint within the clean room, and can have an adverse effect on throughput.

An alternative approach is to have two or more concentric platens with two or more independently controllable rotational speeds. A portion of the substrate is then moved from one position completely overlapping one platen to another position partially overlapping each of two platens, which results in increased or decreased relative velocity between the polishing pad and the substrate at that portion, and thus enables radially-targeted polishing of an edge portion of the substrate.

Assuming the substrate can be laterally moved from one platen to another platen rotating at a different speed, the effect on polishing will depend on the radial position of the substrate and the rotational speed of the platen(s) that support the substrate. Thus, some technique is needed for selecting the radial position of the substrate and the rotational speeds of the platen(s). To address this, a “Preston matrix” can be used for calculation of an expected polishing profile as a function of the control parameter values. The dwell time of the substrate at each of multiple positions and the rotational speed(s) can be treated as control parameters that are part of the Preston matrix. Treating the dwell times and/or rotational speeds as control parameters permits an optimization algorithm to be performed to select the rotational speeds and/or dwell times to provide a desired polishing profile.

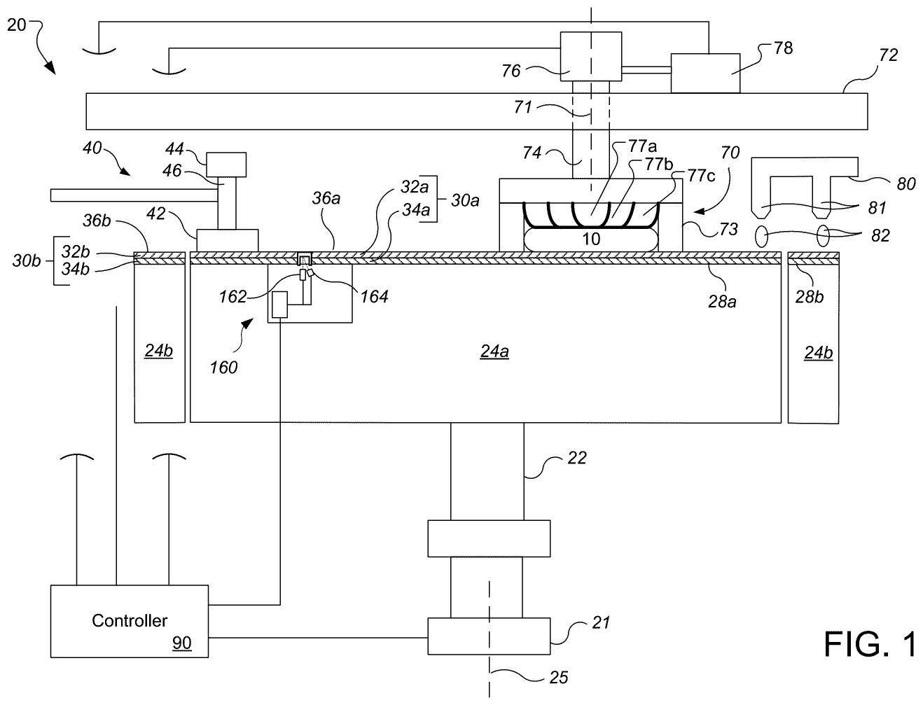

FIG. 1 shows a polishing system 20 operable to polish a substrate 10. The polishing system 20 includes two or more concentric rotatable platens, e.g., inner platen 24a and outer platen 24b, on each of which a polishing pad, e.g., 30a and 30b, is situated. In some implementations, each platen, e.g., inner platen 24a and outer platen 24b, provides an upper surface, e.g., upper surfaces 28a and 28b, to respectively support the polishing pads 30a and 30b. The upper surface 28a of the inner platen 24a can be circular, and the upper surface 28b of the outer platen 24b can be annular. The inner platen 24a and outer platen 24b are concentric, with the upper surface 28b having an inner radius slightly larger, e.g., 0.5 millimeter larger, than the radius of the upper surface 28a.

In some implementations, the inner platen 24a and outer platen 24b are vertically fixed. In this case, the upper surfaces 28a and 28b are coplanar, e.g., the surface of each upper surface is substantially smooth, and the height of each upper surface is substantially equal to the other, e.g., within 1 mm, e.g., within 0.3 mm, e.g., within 0.1 mm of each other. In some implementations, the vertical positions of each of the upper surfaces 28a and 28b are adjustable relative to each other, permitting the vertical positions to be different. For example, actuators (not illustrated), such as pneumatic linear actuators, can provide a vertical force to adjust the vertical position of the inner and outer platens 24a and 24b.

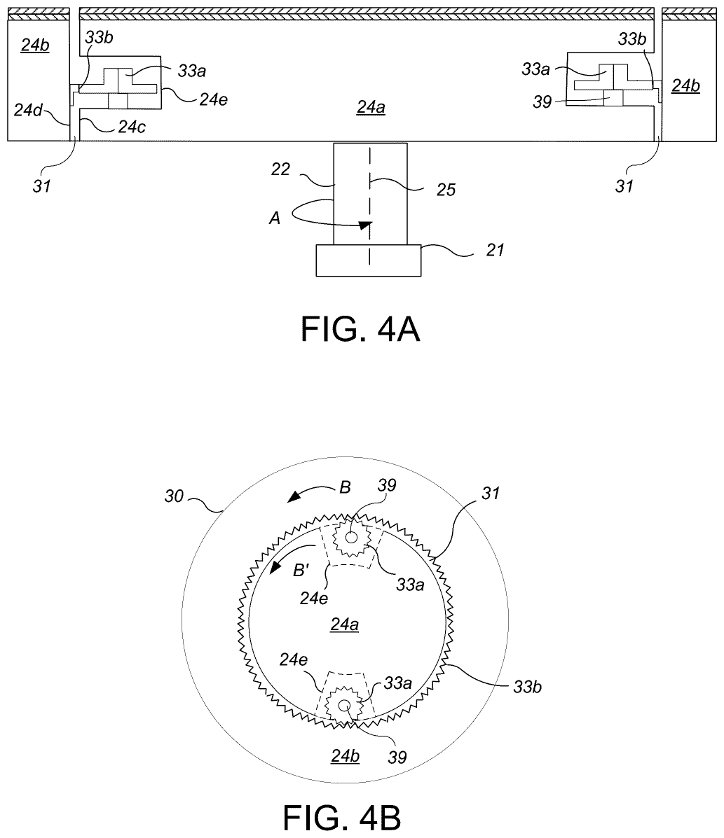

The inner and outer platens 24a and 24b are operable to rotate about a common axis of rotation 25. There are various mechanisms to individually control the rotational speeds of each platen, which will be discussed more in reference to FIGS. 3A and 3B.

The polishing pads 30a and 30b can respectively be secured to the upper surfaces 28a and 28b of the inner and outer platens 24a and 24b, for example, by a layer of adhesive. When worn, the polishing pads 30a and 30b can be detached and replaced. The polishing pads 30a and 30b can each be a two-layer polishing pad with an outer polishing layers 32a and 32b having a polishing surface, and softer backing layers 34a and 34b.

The polishing system 20 can include a polishing liquid delivery arm 82 and/or a pad cleaning system such as a rinse fluid delivery arm. During polishing, the liquid delivery arm 82 is operable to dispense a polishing liquid 80, e.g., slurry with abrasive particles. The polishing liquid delivery arm 82 can include multiple dispensing ports 81, with at least one port 81 positioned over each of the inner platen 24a and the outer platen 24b. In some implementations, there are two separate polishing liquid delivery arms for the two platens 24a, 24b. In some implementations, the polishing system 20 includes a combined slurry/rinse arm. Alternatively, the polishing system can include a port in each platen operable to dispense the polishing liquid 80 onto the polishing pads 30a and 30b. The same polishing liquid can be dispensed on both polishing pads 30a and 30b, or polishing liquids of different composition can be dispensed on the different polishing pads 30a and 30b.

The polishing system 20 can also include a conditioner system 40 with a rotatable conditioner head 42, which can include an abrasive lower surface, e.g., on a removable conditioning disk, to condition the polishing surfaces 36a and 36b of the polishing pads 30a and 30b.

The polishing system 20 includes a carrier head 70 operable to hold the substrate 10 against the polishing pads 30a and 30b. The carrier head 70 is suspended from a support structure 72, for example, a carousel or track, and is connected by a carrier drive shaft 74 to a carrier head rotation motor 76 so that the carrier head can rotate about an axis 71. In addition, an actuator 78 can cause the carrier head 70 to oscillate laterally across the polishing pad, e.g., by moving in a radial slot in the carousel as driven by the actuator, e.g., a linear actuator, by rotation of the carousel as driven by the actuator, e.g., a motor, or movement back and forth along the track as driven by the actuator. In particular, the carrier head 70 is movable from a first position where the substrate 10 is completely over one platen, e.g., the inner platen 24a, to a second position where the substrate partially overlaps the inner platen 24a and partially overlaps the outer platen 24b.

In operation, the inner and outer platens 24a and 24b are rotated about their central axis of rotation 25, and the carrier head is rotated about its axis 71 and translated laterally across the top surface of the polishing pad. Both inner and outer platens 24a and 24b can rotate in the same direction, albeit at different rotational speeds.

The carrier head 70 can include a retaining ring 73 to retain the substrate 10 below a flexible membrane 144. The carrier head 70 also includes one or more independently controllable pressurizable chambers defined by the membrane, e.g., three chambers 77a-77c, which can apply independently controllable pressures to associated zones on the flexible membrane 144 and thus on the substrate 10. Although only three chambers are illustrated in FIG. 1 for ease of illustration, there could be one or two chambers, or four or more chambers, e.g., five chambers.

A controller 90, such as a programmable computer, is connected to the motors 21, 76 to control the rotation rate of each of the inner and outer platens 24a and 24b and carrier head 70, and to the actuator 78 to control the radial position of the carrier head on either or both of the inner and outer platens 24a and 24b. For example, each motor can include an encoder that measures the rotation rate of the associated drive shaft. A feedback control circuit, which could be in the motor itself, part of the controller, or a separate circuit, receives the measured rotation rate from the encoder and adjusts the current supplied to the motor to ensure that the rotation rate of the drive shaft matches a rotation rate received from the controller.

The controller 90 can also control other components of the polishing system, such as pressure regulators to control the pressure in the chambers 77a-77c or a pump to control the flow rate of the polishing liquid.

In many polishing processes, the outer edge of the substrate 10 is polished at a different rate, e.g., under-polished, as compared to the center of the substrate. This results in different, e.g., increased, layer thickness at the edges of the substrate 10 as compared to the center of the substrate. In addition, in the incoming substrate has a non-uniform thickness. In either case, it may be desirable to modify the polishing rate at the substrate edge.

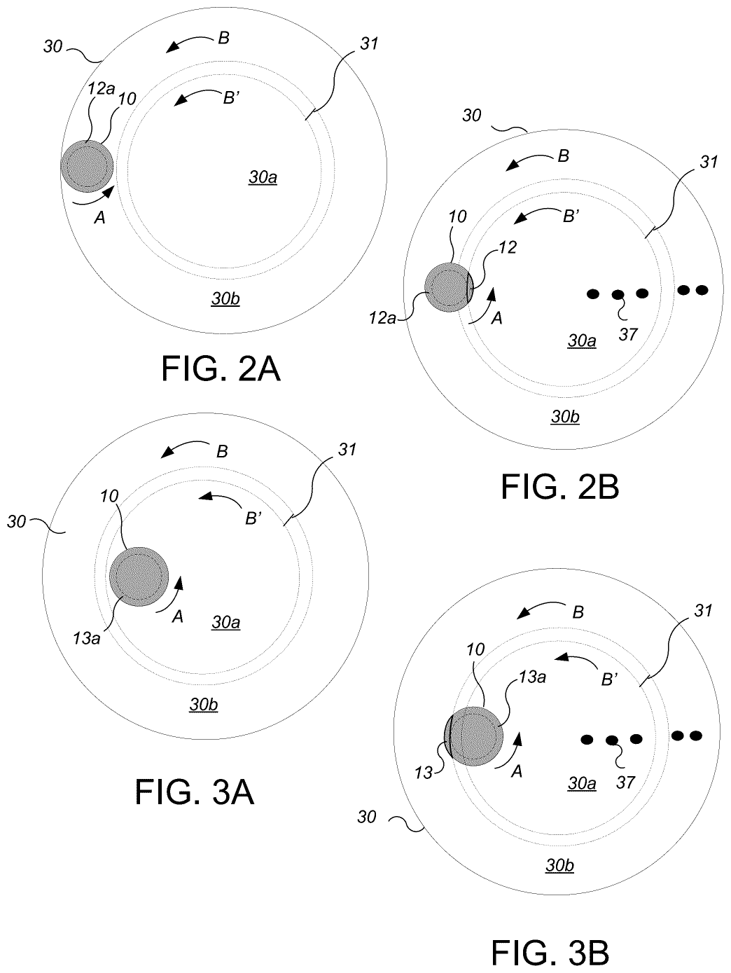

FIGS. 2A and 2B illustrate a schematic top-down view of polishing pads 30a and 30b operable to rotate at different speeds. The carrier head 70 (not shown) can control the lateral position of the substrate 10 such that it can move from completely overlapping either polishing pad 30a or 30b to partially overlapping polishing pads 30a and 30b.

Between the polishing pads 30a and 30b, there can be a gap 31. The gap 31 can be annular with an inner radius equal to the radius of the polishing pad 30a and an outer radius equal to the inner radius of the polishing pad 30b. The width, i.e., difference between the inner and outer radii, of the gap 31 can be on the order of 0.3 millimeters to 3 centimeters.

As shown by FIGS. 2A and 2B, in some implementations, the carrier head is moved between a first position in which the substrate 10 is entirely over the outer polishing pad 30b, and a second position in which the substrate is partially over the outer polishing pad 30b and partially over the inner polishing pad 30a. With reference to FIG. 2B, when the substrate 10 partially overlaps the polishing pads 30a and 30b, a portion 12 of the substrate 10 overlaps the polishing pad 30a. In particular, only an edge portion 12a of the substrate 10, e.g., a convex-lens-shaped section, can overlap the inner polishing pad 30a. The edge portion can have a width along the radial direction of the substrate no larger than about 30 mm. Due to the rotation (shown by arrow A) of the carrier head 70 and substrate 10, an annular section, e.g., edge section 12a of the substrate 10 experiences an increased or decreased polishing rate compared to the rest of the substrate 10 that does not overlap the polishing pad 30a.

As shown by FIGS. 3A and 3B, in some implementations the carrier head is moved between a first position in which the substrate 10 is entirely over the inner polishing pad 30a, and a second position in which the substrate is partially over the inner polishing pad 30a and partially over the outer polishing pad 30b. With reference to FIG. 3B, when the substrate 10 partially overlaps the polishing pads 30a and 30b, a portion 13 of the substrate 10 overlaps the polishing pad 30b. In particular, only a portion 13 of the substrate 10, e.g., a crescent-shaped section can overlap the outer polishing pad 30b. The portion 13 can have a width along the radial direction of the substrate no larger than about 30 mm. Again, due to the rotation (shown by arrow A) of the carrier head 70 and substrate 10, an annular section, e.g., edge portion 13a of the substrate 10 experiences an increased or decreased polishing rate compared to the rest of the substrate 10 that does not overlap the polishing pad 30b.

In the examples of FIGS. 2A-2B and 3A-3B, assuming the substrate edge is otherwise under-polished, the polishing rate for the edge portions 12a and 13a of the substrate 10 that overlap the polishing pads 30a and 30b can increase to compensate and thus improve within wafer and wafer-to-wafer uniformity. For example, in FIGS. 2A-2B, to increase the polishing rate of the edge portion 12a, the inner platen 24a can rotate faster than the outer platen 24b. On the other hand, for FIGS. 3A-3B, to increase the polishing rate of the edge portion 13a, the outer platen 24b can rotate faster than the inner platen 24a. Conversely, assuming the substrate edge is otherwise over-polished, the relative rotation rates can be reversed.

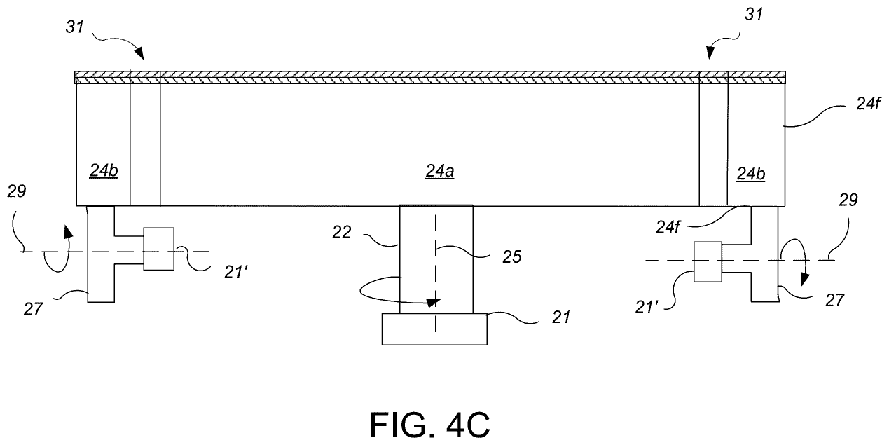

FIGS. 4A-4C illustrate examples of mechanisms used to drive the inner and outer platens 24a and 24b at different rotational speeds. For example, in FIGS. 4A and 4B, a motor 21 can turn a drive shaft 22 to rotate the inner platen 24a (represented by arrow A). The inner platen 24a can be rotatably coupled to the outer platen 24b through a gear system that includes one or more rotatable gears supported on one of the inner or outer platen that engage a geared surface of the other of the inner or outer platen. For example, in the implementation of FIGS. 4A and 4B, two or more rotatable gears 33a are supported partially in recesses 24e in the inner platen 24a. Although FIGS. 4A and 4B show two gears 33a, there could be more, e.g., four or six gears. The toothed circumference of each gear 33a engages a toothed surface 33b that is on or extends from an inner surface 24d of the outer platen 24b. A motor 39 supported on the platen, e.g., in the recess 24e, can power the gear 33a to rotate. Although FIGS. 4A and 4B illustrate the gear 33a extending outwardly beyond the outer surface 24c of the inner platen 24a to engage the toothed surface of the outer platen 24b, this is not necessary. For example, a portion of the outer platen 24b having the toothed surface 33b can extending inwardly into the recess 24 in the inner platen 24a.

When the motor 39 does not rotate, the teeth of the gears 33a and the geared surface 33b are locked in place. Consequently, the outer platen 24b will rotate at the same rotational speed as the inner platen 24a. However, the motor 39 can drive the gears 33a to rotate about their own axes of rotation. Depending on the direction, e.g., clockwise or counterclockwise, and speed of rotation of the rotating gear, the relative speed of the inner and outer platens 24a and 24b can vary. For example, with reference to FIG. 4B, when the inner platen 24a and gears 33a both rotate counter-clockwise, the gears 33a cause the outer platen 24b to rotate faster than the inner platen 24a. Conversely, if the inner platen 24a rotates counter-clockwise, and the gears 33a rotate clockwise, the outer platen 24b will rotate more slowly than the inner platen 24a.

The gears 33a can be equally spaced around the outer surface 24c of the inner platen 24a, e.g., two along a diameter as in FIG. 4B. In addition, the gears 33a can be supported by the outer platen 24b, and engage a toothed outer surface of the inner platen 24a.

As another example, FIG. 4C depicts a polishing apparatus with two separate motors for driving the rotational mechanisms of the inner and outer platens 24a and 24b. A circular flange 27 can be coupled to an additional motor 21′, which causes the flange to rotate about an axis 29. In some implementation, axis 29 is perpendicular to central axis of rotation 25, e.g., horizontal. The edge of the flange 27 can engage with a surface, e.g., lower surface 24f, of the outer platen 24b. For example, a geared surface of the flange 27 can engage a geared surface of the outer platen 24b. Accordingly, when the additional motor 21′ rotates, the outer platen 24b can rotate about the central axis of rotation 25. In some implementations, there are multiple additional motors and flanges spaced, e.g., equally angularly spaced around the axis of rotation 25, under the outer platen 24b.

In some implementations, the outer platen 24b can sit on a bearing and a belt, e.g., an elastic material wrapped around a portion of the outer edge 24f of the outer platen 24b can be driven by a motor to control the rotational speed of the outer platen 24b independent of the rotation of the inner platen 24a.

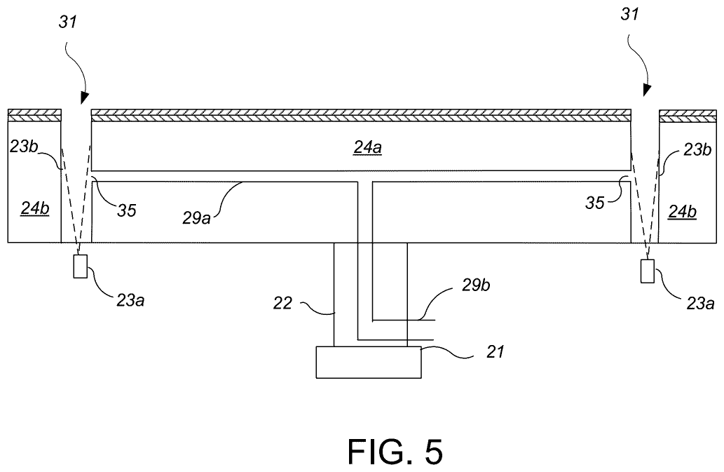

FIG. 5 depicts a polishing apparatus with an example of a rinse system. The rinse system can include one or more nozzles 23a, located and angled such that they can spray a cleaning liquid 23b, e.g., deionized water, into at least a portion of the gap 31. Spraying a cleaning liquid into the gap 31 can prevent buildup of polishing byproducts that could interfere with the rotation of the inner and outer platens 24a and 24b.

The nozzles 23a can be equally or otherwise spaced beneath or above the gap. In some implementations, a top or bottom of one or more nozzles 23 can be within the gap 31.

In some implementations, the rinse system includes a passage 29a through the inner platen 24a and drive shaft 22 with openings 35 to the gap 31. Fluid from an inlet 29b can flow through the passage 29a and into the gap 31 so that byproducts of the polishing process and used cleaning liquid 23b sprayed by the nozzles 23a flow downward out of the gap 31.

Returning to FIG. 1, in some implementations, the polishing apparatus includes an in-situ monitoring system 160, e.g., an optical monitoring system, such as a spectrographic monitoring system which can be used to measure a spectrum of reflected light from a substrate undergoing polishing. The in-situ monitoring system 160 can include a sensor supported on the platen, e.g., an end of an optical fiber that is coupled to a light source 162 and a light detector 164. Due to the rotation of the platen, as the sensor travels below the carrier head 70 and the substrate 10, the in-situ monitoring system 160 receives measurements at a sampling frequency causing the measurements to be taken at locations in an arc that traverses the substrate 10. From the measurements, the in-situ monitoring system 160 produces a signal which depends on the thickness of the layer of material being polished, e.g., a thickness profile. Additionally or alternatively, the in-situ monitoring system 160 produces a signal which depends on the polishing rate of the layer of material being polished, e.g., a polishing rate profile.

The controller 90 receives the signal, converts the signal to a process profile, e.g., a thickness profile or polishing rate profile, and compares the process profile to a target profile. For example, the target profile can be a pre-determined target thickness profile for the radially-dependent thickness of the layer at the end of polishing, or a target polishing rate profile storing radially-dependent target polishing rates during polishing. The process profile can be based on measurements over the radial width of the substrate 10, or a portion of the radial width of the substrate 10. In some implementations, the controller 90 calculates a process profile for the portion of the substrate 10 corresponding to the outermost annular region of the substrate 10, such as the outermost 5%, the outermost 10%, or the outermost 20% of the substrate.

The controller 90 compares the process profile to a target profile. If the process profile differs from the target profile by more than a threshold amount, the controller 90 determines to change a polishing parameter. For example, the rotational speed of the inner and outer platens 24a and 24b can each be altered to compensate for the departure of the process profile from the target profile.

If the polishing rate of the region of the substrate is either above or below a target polishing rate, the controller 90 can determine to position the region over polishing pad 30a, polishing pad 30b, the gap 31, or a combination thereof.

The carrier head 70 passes the substrate 10 over the polishing pads 30a and 30b, and the in-situ monitoring system 160 receives a signal indicative of an updated thickness of the overlying layer of material, e.g., an updated thickness profile, and calculates a new uniformity value for the updated thickness profile.

The controller 90 compares the updated uniformity value to the uniformity threshold. If the uniformity value is below the uniformity threshold, the controller 90 determines to discontinue increased polishing of the region of the substrate 10 corresponding with the region exceeding the uniformity threshold.

The polishing rate (i.e., the rate at which material is removed from the substrate 10) can vary according to several polishing system control parameters, e.g., the dwell time of the carrier head 70 and substrate 10 at each of a plurality of radial distances 37 (see FIG. 2A) from the axis of rotation 25 of the inner and outer platens 24a and 24b, as well as the pressure in the chambers 77a-77c, the pressure on the retaining ring 73, the rotation rate of the carrier head 70, and the rotation rate of each of (or the difference in rotation rate between) the inner and outer platens 24a and 24b. As such, the combination of such parameters can determine the surface profile of the substrate 10 after polishing.

In general, the polishing system 20 is controlled in an attempt to make the post-polished substrate have a target surface profile, e.g., a target thickness across the substrate surface. The target surface profile may be uniform (e.g., planar) or non-uniform across the substrate surface. The target surface profile can be set as a function of distance from center of the substrate 10, e.g., with an assumption that polishing is angularly symmetric, although this is not required. The target surface profile can be set manually by a manufacturer of the polishing system, set manually by an operator of the polishing system, e.g., an employee of the semiconductor fab, or could be generated automatically by computer software based on measurements of the performance of other tools at the semiconductor fab, e.g., to compensate for non-uniform deposition or removal by the other tools.

The controller 90 can be configured to store a target removal profile. The controller 90 uses the target removal profile to set values for the polishing control parameters for the polishing system 20, e.g., the pressures in the chambers 77a-146c of the carrier head 140, the dwell time of the carrier head 70 and substrate 10 at each of a plurality of radial distances from the axis of rotation 25 of the inner and outer platens 24a and 24b, and the difference in rotation rate between the inner and outer platens 24a and 24b. The target removal profile represents a desired amount of material to be removed across the front surface of the substrate. In some implementations, the target removal profile can be determined, e.g., by the controller 90 or another computer system which forwards the target removal profile to the controller 90, based on an initial surface profile of the substrate 10 (e.g., as measured at a metrology station prior to polishing or by an in-situ monitoring system). For example, the target removal profile can be calculated as

$$TRP = ISP - TSP \qquad ( 1 )$$

where TRP is the target removal profile, ISP is the initial surface profile, and TSP is the target surface profile. Alternatively, if the initial surface profile is unknown, then the initial surface profile can be set to a default value. Also, in some situations, the operator of the polishing system may desire to remove a target amount from the substrate rather than achieve a target profile. In addition, in some situations, the operator of the polishing system may simply set the target removal profile, e.g., based on a priori principals or previous experience. In this last case, the user can generate the target removal profile by user input, e.g., to the controller 90 or to another computer system which forwards the target removal profile to the controller 90.

The controller 90 can generate and store an expected removal profile (that is, the amount of material expected to be removed across the front surface of substrate 10) for a given set of values for the polishing control parameters.

In general, it is advantageous to select values for the polishing control parameters, e.g., the pressures in the chambers 77a-77c of the carrier head 70, the dwell time of the carrier head 70 at each of a plurality of radial distances from the axis of rotation 25 of the inner and outer platens 24a and 24b, and the difference in rotation rate between the inner and outer platens 24a and 24b, so that the expected removal profile closely approximates (including exactly matches) the target removal profile. For example, if the expected removal profile closely approximates the target removal profile, then the actual removal profile, i.e., the amount actually removed from a substrate during polishing, should also closely approximate the target removal profile.

It should be noted that the removal profile described herein may be expressed as an amount of material removed from the substrate surface or, equivalently, as a material removal rate (e.g., by dividing removal profile by an actual or expected time spent polishing). Further, it should also be understood that the data used for the calculation could be stored in various different units, so long the data is converted into consistent units for the purpose of calculation.

As a simplified model, the expected removal rate for any given location can depend linearly on each polishing control parameter. That is, assuming only one polishing control parameter is varied while other polishing control parameters remain constant, then the removal rate at each radial location on the substrate can be a linear function of the polishing control parameter that is being varied.

A relationship between the polishing control parameters and the removal profile can be determined based on measured data. For example, removal profiles can be measured for test substrates, with each test substrate being polished using a different set of calibration values for the polishing control parameters. In particular, one substrate can be polished under a set of baseline calibration values for the polishing control parameters, and a baseline removal profile is measured from the one substrate. Then, for each control parameter that is to be set by the process, an additional substrate is polished, with that control parameter set to a modified calibration value that is different from the baseline calibration value (but the other control parameters set to their baseline calibration values), and an adjusted removal profile is measured from the additional substrate.

In some implementations, the various profiles generated from experimental measurement, e.g., the base removal profile and the adjusted removal profile, includes measured removal values for a plurality of positions under each chamber. Similarly, the calculated expected removal includes calculated values for the expected removal at multiple positions under each chamber. In some implementations, the profiles, e.g., the base removal profile, the adjusted removal profile and expected removal profile, include values for twenty to three hundred positions on the substrate. For example, the profiles can include values for positions on the substrate at a regular spacing of 1 mm.

In some implementations, the expected removal profile can be calculated as

$$ERP = BRP + [ K ] [ {P}^{′} ] * BRP * VAP \qquad ( 2 )$$

where ERP is a row vector of M values for the expected removal profile, BRP is row vector of M values for a baseline removal profile, [K] is a matrix of constants (termed the “Preston matrix”) having a number of columns equal to the total number of polishing control parameters, N, and a number of rows equal to the total number of radial positions, M, on the substrate surface where the profile is measured (an M×N matrix), [P′] is a column vector of N adjusted polishing control parameter values, and VAP is a column vector of M values that represent relative velocity changes as a function of the location on the substrate due to the inner and outer platens rotating at different rates. Here the “*” operation indicates multiplication of respective entries in the vectors, rather than a dot or cross-product. That is, the i-th component of ERP is equal to the i-th component of BRP plus the i-th component of the column vector resulting from [K] [P′] times the i-th component of BRP times the i-th component of VAP. The total number of positions M can be greater than the number of chambers in the carrier head, and can be greater than the total number of polishing control parameters N.

The baseline removal profile can be determined by polishing a test wafer at a set of default polishing control parameter values, P0₁, P02, . . . . P0_{N}, and comparing a measured (e.g., at a metrology station) surface profile after polishing to the initial surface profile. For example, the baseline removal profile can be calculated as

$$BRP = ISP - BSP \qquad ( 3 )$$

where BRP is the baseline removal profile, ISP is the initial surface profile, and BSP is the baseline surface profile achieved as a result of polishing a test substrate at the default polishing control parameter values P0₁, P0₂, . . . . P0_{N}.

The constants of the matrix [K] can be determined from on the baseline removal profile and the modified removal profiles. As noted above, the modified removal profiles can be generated by polishing an additional substrate for each parameter while modifying that parameter, one substrate at a time. For example, a modified removal profile can be calculated for each modified parameter according to the equation

$${ARP}_{i} = ISP - {ASP}_{i} \qquad ( 4 )$$

where ARPᵢ is the adjusted removal profile resulting from adjustment of the i^{th} polishing parameter, ISP is the initial surface profile, and ASPᵢ is the adjusted surface profile measured as a result of adjusting the i^{th} parameter.

In particular, the constant values of the matrix [K] can be calculated as

$${K}_{x , i} = \frac{{ARP}_{x , i} - {BRP}_{x}}{{BRP}_{x} * [ \frac{{PA}_{i} - P {0}_{i}}{P {0}_{i}} ]} \qquad ( 5 )$$

where K_{x,i} is the value of the matrix [K] corresponding to the substrate profile position x for the i^{th} parameter, ARP_{x,i} is the amount of material removed at radial position x for the i^{th} adjusted parameter, BRPₓ is the amount of material removed at radial position x according to the previously calculated baseline removal profile, PAᵢ is the i^{th} parameter value used to generate the i^{th} adjusted removal profile, and P0ᵢ is the i^{th} parameter value for the baseline removal profile.

As such, the matrix [K] can be expressed as

$$[ K ] = [ \begin{matrix}{K}_{1 , 1} & … & {K}_{1 , N} \\ ⋮ & ⋱ & ⋮ \\ {K}_{M , 1} & … & {K}_{M , N}\end{matrix} ] \qquad ( 6 )$$

where M is the total number of radial substrate positions x at which profile measurements are taken and N is the total number of parameters.

The variable expressions of the vector [P′], P₁′, P₂′ . . . . P_{N}′ are defined by

$${P}_{i}^{′} = \frac{{P}_{i} - P {0}_{i}}{P {0}_{i}} \qquad ( 7 )$$

where Pᵢ′ is the value of the vector [P′] corresponding to the i^{th} parameter, P0ᵢ is the i^{th} parameter value for the baseline removal profile, and Pᵢ is the variable proposed parameter value.

Thus, the expected removal profile can be expressed as

$$ERP = BRP + [ \begin{matrix}{K}_{1 , 1} & … & {K}_{1 , N} \\ ⋮ & ⋱ & ⋮ \\ {K}_{M , 1} & … & {K}_{M , N}\end{matrix} ] [ \begin{matrix}{P}_{1}^{′} \\ ⋮ \\ {P}_{N}^{′}\end{matrix} ] * BRP \qquad ( 8 )$$

where ERP is the expected removal profile, BRP is the baseline removal profile, and values for the matrix [K] and the vector [P′] are calculated as described above with reference to equations (5) and (7).

The polishing control parameters can include a parameter representing a pressure for each chamber 77a-77c in the carrier head 70. Thus, at least two of the polishing control parameters are carrier head chamber pressures. The values for the chamber pressures can be in units of psi, although other units, e.g., Pascal, are possible.

The polishing control parameters can include a first parameter representing a rotation rate of the inner platen 24a and a second parameter representing a rotation rate of the outer platen 24b. The value for a rotation rate can be in units of rpm, although other units, e.g., drive current for the respective motor, are possible.

Alternatively, the polishing control parameters can be a single parameter representing a difference in rotation rates between the inner platen 24a and the outer platen 24b. In this case, the rotation rate of one of the platens, e.g., the platen over which the substrate is sometimes entirely positioned (e.g., the outer platen 24b in the implementation of FIGS. 2A-2B, and the inner platen 24a in the implementations of FIGS. 3A-3B) can be set by a polishing recipe that is selected prior to the polishing operation. Then the rotation rate of the other platen (e.g., the inner platen 24a in the implementation of FIGS. 2A-2B, and the outer platen 24b in the implementations of FIGS. 3A-3B) is given by the rotation rate in the recipe as adjusted by the difference in rotation rates given by the parameter. An advantage of using a single parameter representing the difference in rotation rates is that it can be simpler to model and easier to calculate.

In order to set a sweep profile for the carrier head 70, the polishing control parameters can include multiple parameters representing dwell times. In particular, each respective parameter of the multiple parameters can represent the dwell time of the carrier head at a different respective radial annular zone on the platen.

During operation, the carrier head 70 sweeps laterally over the inner and outer platens 24a and 24b and polishing pad (indicated by arrow C), e.g., along a radius of the inner and outer platens 24a and 24b. For each zone, there can be a corresponding dwell time control parameter representing a dwell time of the carrier head 70 within or at that zone. The substrate may span multiple zones, in which case each respective dwell time control parameter can represent a dwell time of the center point of the carrier head (at axis 71) within or at that respective zone. The value for a dwell time parameter value can be in units of the fraction of total time (i.e., the total of all dwell times would equal 1), although other units, e.g., expected time, e.g., seconds, are possible.

Once the dwell time parameter values are calculated (calculation of the parameter values is discussed below), the dwell time parameter values can be converted into a sweep profile. In general, in the sweep profile the dwell time for each zone will be apportioned according to the dwell time parameter value.

In some implementations, the carrier head sweeps with a speed that is constant within each zone, but which can be different for each zone. For example, referring to FIG. 4B, one possible technique is to set the carrier head sweep rate (i.e., the slope of the line 202) for each zone 200a-200f according to the inverse of the fraction indicated by dwell time parameter for that zone. For example, given an oscillation period T, the dwell time for a half sweep (either inward or outward) for a given zone i can be calculated as T*DT_{i/2}, where DTᵢ is the fractional dwell time value for the i^{th} zone. For example, the amount of time T₁ spent by the center of the substrate 10 in the outermost zone 200a during an inward sweep would be T*DT₁/2. Then the speed at which the carrier head sweeps across a particular zone i can be (R₁ᵢ/R₂ᵢ)/(Tᵢ), where R1ᵢ and R2ᵢ are the inner and outer diameters of the i^{th} zone. As a result, the speed of the carrier head and slope of the line 202 during time Tᵢ would be 2*(R₁₁/R₂₁)/(T*DT₁).

As another example, the control parameters, such as the sweep profile and rotation rate of the inner and outer platens 24a and 24b, can be determined such that only particular angular swaths of a substrate are exposed to the outer platen. This example can be useful for correction for edge asymmetry.

In some implementations, a suitable combination of parameters can be determined by solving for respective parameters that minimize a difference between the expected removal profile and the target removal profile. That is, the value of ERP-TRP is minimized. In many cases, one or more distinct sets of parameters can be determined mathematically that provide an expected removal profile equaling the target removal profile, such that ERP-TRP=0. In other cases, a difference value between the expected removal profile and the target removal profile can be minimized to an acceptable, non-zero value by using the following equation

$$Δ = {\sum }_{x = 1}^{M} {( {ERP}_{x} - {TRP}_{x} )}^{2} \qquad ( 9 )$$

where Δ is a difference value, ERPₓ is the variable value of the expected removal profile at a radial position x on the substrate and TRPₓ is the constant value of the target removal profile at the radial position x. Values of Pᵢ can be calculated to find an expected removal profile that closely approximates the target removal profile.

In some examples, an iterative process (e.g., Newton's method of optimization) may be used in conjunction with equation (9) to determine an appropriate combination of parameter values to find a minimum difference between the estimated pressure profile and the target pressure profile, e.g., to find a minimum value for A. For example, a commercially available solver function (e.g., the Microsoft Excel solver function, the MATLAB solver function, and/or the Wolfram Mathematica solver function, etc.) may be used to determine an appropriate combination of parameter values. In some cases, there may be several suitable combinations of parameter values.

Once an appropriate set of parameter values has been determined, as described above, the controller 190 can be configured to store the parameter values and execute a polishing technique accordingly to provide one or more substrates having the target surface profile.

In most cases, when all other parameter values are to be held constant, the polishing rate at a particular location on the substrate 10 can vary linearly with the pressure applied to the substrate, at that location of the substrate, on the polishing pad.

In some examples, an iterative process (e.g., Newton's method of optimization) may be used in conjunction with either of equations (16) or (17) to determine an appropriate combination of chamber pressures to find a minimum difference between the estimated pressure profile and the target pressure profile, e.g., to find a minimum value for A. For example, a commercially available solver function may be used to determine an appropriate combination of chamber pressures. In some cases, there may be several suitable combinations of chamber pressures.

Once an acceptable expected pressure profile is determined, interpolation and/or extrapolation techniques (other known mathematical approximation techniques may also be used) can be applied to the measured baseline pressure distributions to determine a corresponding chamber pressure for each chamber. When using pressure distributions from a single baseline pressure it may be necessary to assume a zero scale pressure distribution (i.e., when the chambers are not pressurized, there is little or no polishing pressure applied).

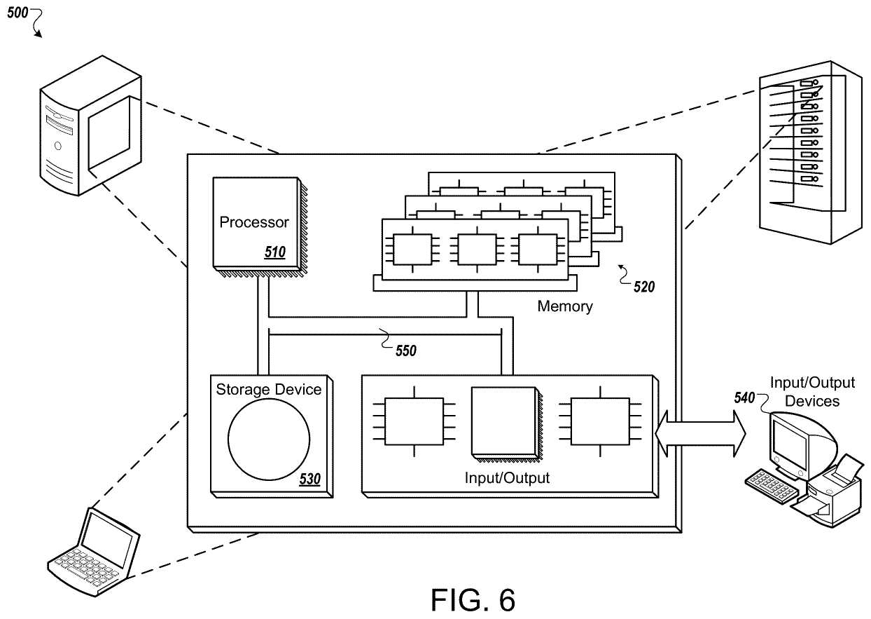

FIG. 6 is a block diagram of an example computer system 500. For example, controller 190 can be an example of the system 500 described here, as could a computer system used by any of the users who access resources of the system 500. The system 500 includes a processor 510, a memory 520, a storage device 530, and one or more input/output interface devices 540. Each of the components 510, 520, 530, and 540 can be interconnected, for example, using a system bus 550.

The processor 510 is capable of processing instructions for execution within the system 500. The term “execution” as used here refers to a technique in which program code causes a processor to carry out one or more processor instructions. In some implementations, the processor 510 is a single-threaded processor. In some implementations, the processor 510 is a multi-threaded processor. The processor 510 is capable of processing instructions stored in the memory 520 or on the storage device 530. The processor 510 may execute operations such as controlling a polishing operation as described herein.

The memory 520 stores information within the system 500. In some implementations, the memory 520 is a computer-readable medium. In some implementations, the memory 520 is a volatile memory unit. In some implementations, the memory 520 is a non-volatile memory unit.

The storage device 530 can provide mass storage for the system 500. In some implementations, the storage device 530 is a non-transitory computer-readable medium. In various implementations, the storage device 530 can include, for example, a hard disk device, an optical disk device, a solid-state drive, or a flash drive. In some implementations, the storage device 530 may be a cloud storage device, e.g., a logical storage device including one or more physical storage devices distributed on a network and accessed using a network.

The input/output interface devices 540 provide input/output operations for the system 500. In some implementations, the input/output interface devices 540 can include one or more of a network interface device, e.g., an Ethernet interface, and/or a wireless interface device. A network interface device allows the system 500 to communicate, for example, transmit and receive data by way of a network. In some implementations, mobile computing devices, mobile communication devices, and other devices can be used.

Software can be realized by instructions that upon execution cause one or more processing devices to carry out the processes and functions described above. Such instructions can include, for example, interpreted instructions such as script instructions, or executable code, or other instructions stored in a computer readable medium.

Although an example processing system has been described in FIG. 5, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as storing, maintaining, and displaying artifacts can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. Computer readable media suitable for storing computer program instructions and data include all forms of non-volatile or volatile memory, media and memory devices.

Throughout the specification, reference to a measurable value such as an amount, a temporal duration, and the like, the recitation of the value should be taken as disclosure of the precise value, of disclosure of approximately the value, and of disclosure of about the value, e.g., within ±10% of the value. For example, here reference to 100 microns can be taken as a reference to any of precisely 100 microns, approximately 100 microns, and within ±10% of 100 microns.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

What is claimed is:

1. A chemical mechanical polishing apparatus, comprising:
an inner platen to support an inner polishing pad;
an annular outer platen to support an outer polishing pad, wherein the outer polishing pad coaxially surrounds the inner platen, and an outer edge of the inner platen and an inner edge of the outer platen are separated by a gap;
a carrier head to hold a substrate;
a first motor to rotate the inner platen about a vertical axis at a first rotation rate; and
a second motor to rotate the outer platen about the vertical axis at a second rotation rate.

2. The apparatus of claim 1, comprising a drive shaft colinear with the vertical axis coupling the first motor to the inner platen.

3. The apparatus of claim 1, further comprising a first gear attached to one of the inner platen or outer platen and positioned to engage a toothed surface of the other of the inner platen or outer platen, wherein the first gear is driven by the second motor and rotates about a second vertical axis.

4. The apparatus of claim 3, wherein the first gear is attached to the inner platen and is positioned to engage a toothed surface of the outer platen, and the second vertical axis moves with the inner platen.

5. The apparatus of claim 4, wherein the second motor is supported in a recess in the inner platen.

6. The apparatus of claim 3, wherein the first gear is attached to the outer platen and is positioned to engage a toothed surface of the inner platen, and the second vertical axis moves with the outer platen.

7. The apparatus of claim 6, wherein the second motor is supported in a recess in the outer platen.

8. The apparatus of claim 1, further comprising at least one geared flange engaged with a geared surface of the outer platen, wherein the second motor drives rotation of the geared flange to causes rotation of the outer platen.

9. The apparatus of claim 8, wherein the geared flange rotates about a horizontal axis and engages a lower surface of the outer platen.

10. The apparatus of claim 8, wherein the geared flange rotates about a vertical axis and engages a cylindrical outer surface of the outer platen.

11. The apparatus of claim 1, comprising a belt that engages an outer surface of the outer platen, wherein the belt is driven by the second motor.

12. The apparatus of claim 1, further comprising one or more nozzles for spraying a cleaning liquid into the gap.

13. The apparatus of claim 1, further comprising a passage through the inner platen with one or more openings into the gap and out of the inner platen.

14. The apparatus of claim 13, further comprising a cleaning liquid source coupled to the passage to direct cleaning liquid through the one or more openings into the gap.

15. A chemical mechanical polishing apparatus, comprising:
an inner platen to support an inner polishing pad;
an annular outer platen to support an outer polishing pad, wherein the outer polishing pad coaxially surrounds the inner platen, and an outer edge of the inner platen and an inner edge of the outer platen are separated by a gap;
a carrier head to hold a substrate;
one or more motors to rotate the inner platen about a vertical axis at a first rotation rate and rotate the outer platen about the vertical axis at a second rotation rate; and
one or more nozzles positioned to spray a cleaning liquid into the gap.

16. The apparatus of claim 15, further comprising a conduit through the inner platen or the outer platen with one or more openings in a sidewall of the inner platen or the outer platen into the gap.

17. The apparatus of claim 15, wherein the nozzles are horizontally fixed.

18. The apparatus of claim 15, further comprising a deionized water source to provide cleaning fluid to the one or more nozzles.

19. A chemical mechanical polishing apparatus, comprising:
an inner platen to support an inner polishing pad;
an annular outer platen to support an outer polishing pad, wherein the outer polishing pad coaxially surrounds the inner platen, and an outer edge of the inner platen and an inner edge of the outer platen are separated by a gap;
a carrier head to hold a substrate;
one or more motors to rotate the inner platen about a vertical axis at a first rotation rate and rotate the outer platen about the vertical axis at a second rotation rate;
a conduit through the inner platen or outer platen with one or more openings in a sidewall of the inner platen or outer platen into the gap; and
a cleaning liquid source coupled to the passage to direct cleaning liquid through the one or more openings into the gap.

20. The apparatus of claim 19, wherein the conduit is through the inner platen and has one or more openings in the sidewall of the inner platen.

21. The apparatus of claim 19, wherein the conduit is through the outer platen and has one or more openings in the sidewall of the outer platen.

22. The apparatus of claim 19, further comprising a cleaning liquid source coupled to the conduit to direct the cleaning liquid through the one or more openings into the gap.

23. The apparatus of claim 19, wherein the cleaning liquid is deionized water.
